(19) United States
(12) Patent Application Publication
(10) Pub. No.: US 2009/0104848 A1
(43) Pub. Date: Apr. 23, 2009

(54) Calibration tool and a grinder machine including such a tool

(76) Inventors: Jean-Marc Meunier, Oissel (FR); Jean-Emmanuel Merisse, Tourneville (FR)

Correspondence Address: WENDEROTH, LIND & PONACK, L.L.P., 1030 15th Street, N.W.,, Suite 400 East, Washington, DC, 20005-1503, US

(21) Appl. No.: 11/920,057

(22) PCT Filed: May 4, 2006
(86) PCT No.: PCT/FR2006/001005

§ 371 Date: Nov. 8, 2007

(30) Foreign Application Priority Data
May 13, 2005 (FR) 0504857

(51) Int. Cl. B24B 47/22; B24B 9/14; G01B 7/012; B24B 49/00

(52) U.S. Cl. 451/9; 33/558

(57) ABSTRACT

The invention relates to a calibration tool (40) for a machine for milling an ophthalmic lens, comprising two lens holder shafts supported on a carriage, and means for moving said shafts. The calibration tool (40) includes a holder (68) mountable on the lens holder shafts, at least one piezoelectric element (92) attached to the holder (68), and at least one sensor member (72) supported on the holder (68) and comprising a sensing area (124) and at least one bearing surface (132, 134) for exerting pressure on the piezoelectric element (92) when the sensing area (124) contacts a surface of the milling machine (2) so that said element generates a contact detection signal. The invention is useful for calibrating milling machines.

The present invention relates to a calibration tool for a grinder machine for grinding an ophthalmic lens, the machine having two lens-carrier half-shafts carried by a carriage and means for displacing said half-shafts, and the invention also relates to a grinder machine including such a calibration tool.

In order to grind ophthalmic lenses accurately and automatically, it is necessary to know accurately the position of each grindwheel in a set of grindwheels, and possibly also the position of each element of auxiliary tooling such as a small grindwheel for grooving or beveling, or a small drill bit.

For this purpose, it is known to place a metal calibration tool of known radius between the lens-carrier half-shafts of a carriage and, to move the carriage substantially radially relative to the axis of the grindwheels by moving a support plunger until the calibration tool comes to bear against a grindwheel. The tool coming to bear against a grindwheel of the set of grindwheels is detected by the loss of contact with the plunger of the carriage displacement means.

Nevertheless, such detection of loss of plunger contact is not very accurate, and is lacking in repeatability since the measurement is performed with the weight of the carriage resting on the calibration tool. Consequently, deformation of the carriage and of the lens-carrier half-shafts degrades the measurement taken. In addition, that method leads to substantial forces being applied to the surfaces of the grindwheels.

Furthermore, in order to determine the axial positions of the grindwheels or of the auxiliary tooling, the carriage is displaced in translation along an axis perpendicular to the axis of the lens-carrier half-shaft by a stepper motor driving displacement in translation, until a step of the motor does not correspond to any displacement.

Nevertheless, that method generates large forces on the grindwheels, which grindwheels may be fragile. Furthermore, the loss of a step on the stepper motor gives rise to a measurement of accuracy that is no better than plus or minus two steps. Such measurement is not sufficient for adjusting the grinder machine accurately.

An object of the invention is to provide a calibration tool that is more accurate and that does not run the risk of damaging the grindwheels or the auxiliary tooling of the grinder machine.

To this end, the invention provides a calibration tool of the above-specified type, characterized in that it comprises a support adapted to be mounted on the lens-carrier half-shafts; at least one piezoelectric element fastened to the support; and at least one feeler member carried by the support, the feeler member having a feeler region and at least one bearing surface suitable, on contact being made between the feeler region and a surface of the grinder machine, for applying a pressure on the piezoelectric element to cause it to generate a detection signal representative of said contact.

In particular embodiments, the calibration tool includes one or more of the following characteristics:
the feeler member is mounted to move relative to the support and is suitable for being displaced relative thereto in the event of contact being made between the feeler region and a surface of the grinder machine;
the tool further comprises a resilient element connecting the support to the feeler member, the resilient element being deformed in the event of the feeler member coming into contact with the surface of the grinder machine;
the support includes at least one abutment for limiting the displacement stroke of the feeler region of the feeler member;
the feeler member includes at least two bearing surfaces, each suitable for applying pressure on respective distinct faces of the piezoelectric element, and the piezoelectric element is suitable for generating two detection signals, each characteristic of the face on which the pressure is applied;
the feeler member includes an angled portion (bent portion) connecting a fastener portion fastened to the resilient element to a contact portion, the fastener portion being suitable for being displaced solely in a direction substantially perpendicular to the axis of the lens-carrier half-shafts during displacement of the contact portion, whether in a direction perpendicular to, or in a direction parallel to, the axis of the lens-carrier half-shafts;
the feeler region of the feeler member is suitable for being displaced solely in a direction substantially perpendicular to the axis of the lens-carrier half-shafts;
the tool includes a second piezoelectric element fastened to the support, and a second feeler member suitable for being displaced solely in a direction substantially parallel to said axis of the lens-carrier half-shafts, and suitable for applying pressure against the second piezoelectric element in the event of contact with a second surface of the grinder machine;
the or each piezoelectric element comprises a piezoelectric plate rigidly fastened via one end to the support, and projecting therefrom, said bearing surface of the feeler member being adapted to co-operate with the free end of the piezoelectric plate;
the resilient element comprises a resilient membrane mounted on the support close to the piezoelectric element in such a manner as to present a face facing the piezoelectric element and an opposite face, the bearing surface of the feeler member being fastened on the opposite face of the resilient membrane so that the bearing surface is suitable for applying pressure on the piezoelectric element by deformation of the resilient membrane during displacement of the feeler member; and
the resilient element is a thin plate.

The invention also provides a grinder machine of the type including two lens-carrier half-shafts carried by a carriage and means for displacing said half-shafts, the grinder machine being characterized in that it includes a calibration tool as mentioned above.

The invention can be better understood on reading the following description given purely by way of example and made with reference to the drawings, in which:

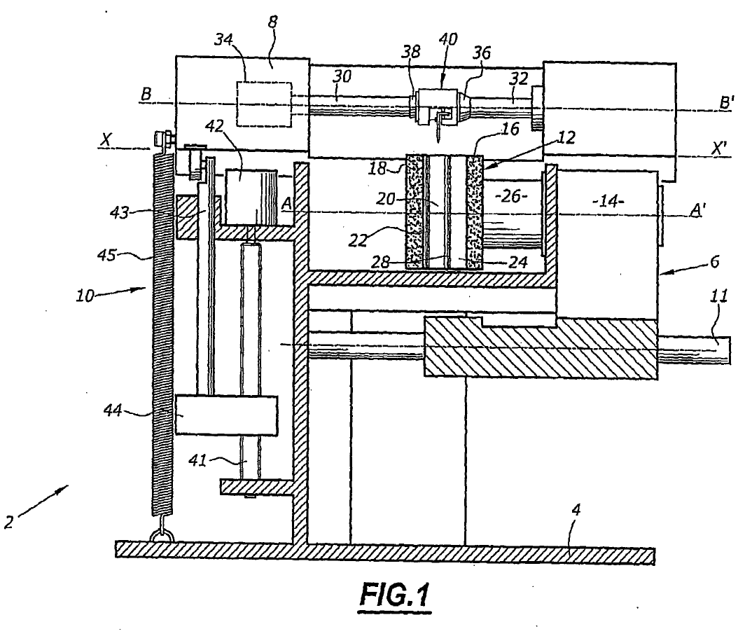

FIG. 1 is a diagrammatic face view of a grinder machine comprising a set of grindwheels and supporting a calibration tool in accordance with the invention;

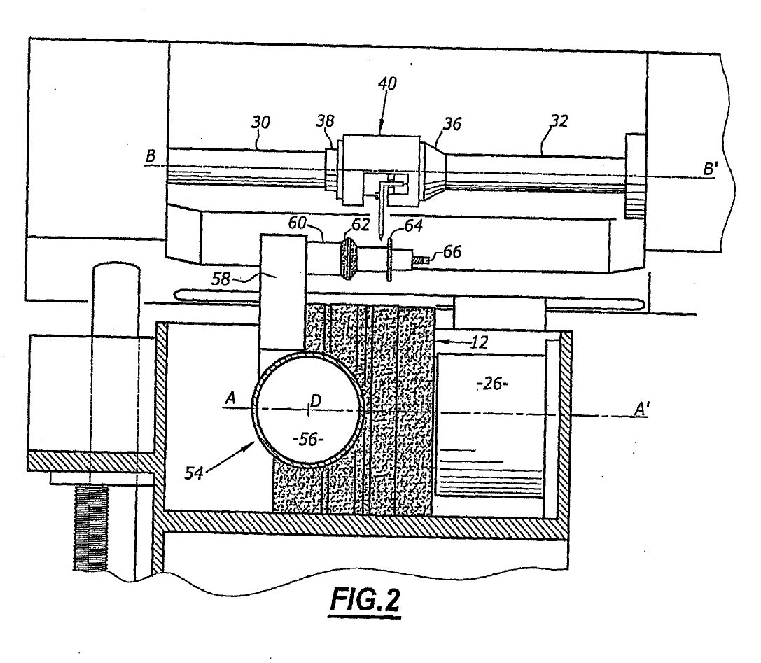

FIG. 2 is a face view of a portion of the grinder machine shown in FIG. 1, together with an auxiliary tool not shown in FIG. 1;

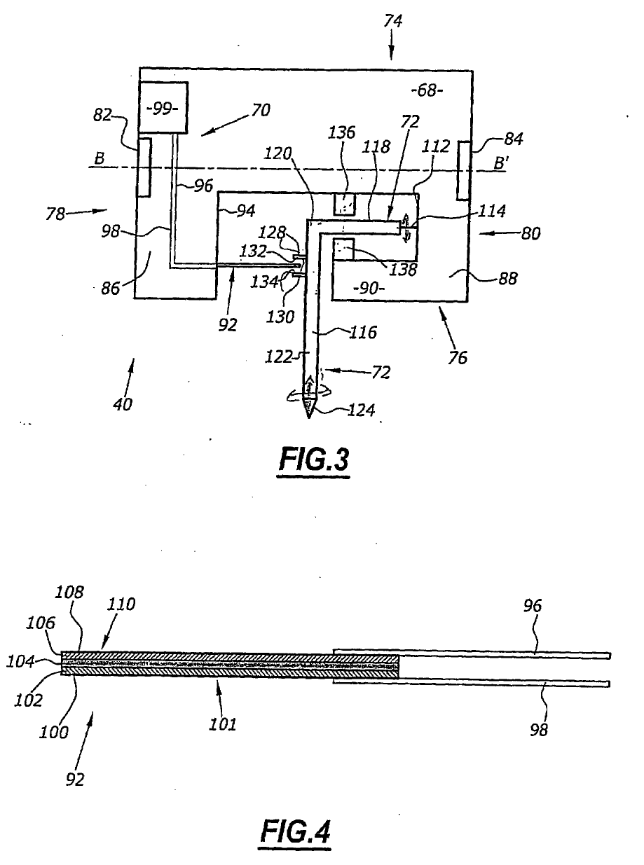

FIG. 3 is a diagrammatic view on a larger scale of the calibration tool of FIGS. 1 and 2;

FIG. 4 is a diagrammatic longitudinal section view of a piezoelectric plate mounted in the calibration tool shown in FIG. 3;

FIG. 5 is a diagrammatic view of the calibration tool shown in FIG. 3, during contact between the tool and a grindwheel when the contact force is directed in a direction parallel to the axis of the lens-carrier half-shaft; and

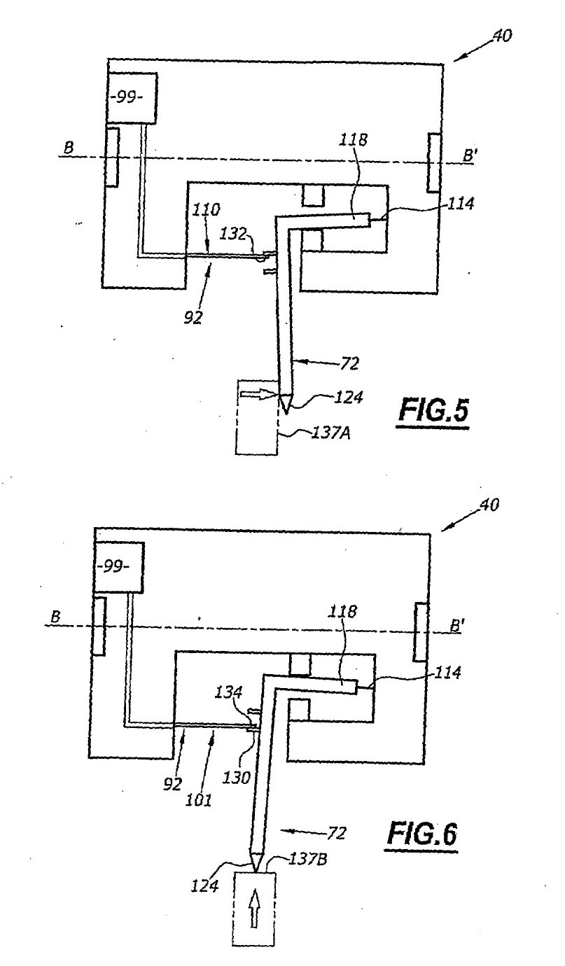

FIG. 6 is a diagrammatic view similar to the view shown in FIG. 5, when the contact force is directed in a direction perpendicular to the axis of the lens-carrier half-shaft.

The grinder machine 2 for receiving the calibration tool of the invention is shown diagrammatically in FIGS. 1 and 2.

This grinder machine 2 comprises a stationary structure 4, a grinder assembly 6, and a carriage 8 for supporting ophthalmic lenses, the assembly and the carriage being mounted on the structure 4, and means 10 for causing the carriage 8 to move relative to the grinder assembly 6.

The grinder assembly 6 has a set of grindwheels 12 mounted to rotate about a first horizontal axis A-A′ in the structure 4, and driven to rotate rapidly by a motor 14.

The set of grindwheels 12 is made up of a plurality of grindwheels mounted side by side and secured to a grindwheel shaft 26. By way of example, it is constituted by a grindwheel 16 for roughing-out mineral lenses, a grindwheel 18 for roughing-out synthetic lenses, a grindwheel 20 for finishing with beveling having a circular groove 22, and a grindwheel 24 for polishing with beveling provided with a circular groove 28.

The carriage 8 is hinged about a second axis X-X′ for rocking, situated behind the plane of FIG. 1 and parallel to the first axis A-A′, which axis A-A′ is contained in the plane of FIG. 1.

The carriage 8 is provided with lens-carrier half-shafts 30 and 32 and with a motor 34 for driving the drive half-shaft 30 to rotate slowly. The half-shafts 30 and 32 are disposed on a third horizontal axis B-B′ parallel to the first axis A-A′. They are provided with mutually-facing free ends 36 and 38 adapted to clamp the ophthalmic lens that is to be ground during a grinding operation or to hold a calibration tool 40 during an operation for measuring the positions of the grindwheels or the position of a tool-carrier assembly, that is described below.

The means 10 for moving the carriage 8 relative to the grinder assembly 6 comprise means (not shown) for axially displacing the grinder assembly 6 along a support-rod 11 parallel to the axis A-A′, and means for displacing the carriage 8 substantially radially relative to the axis A-A′ and constituted by means for rocking about the axis X′-X between a position in which the carriage is remote from the axis A-A′, and an active position in the vicinity of the axis A-A′.

The rocker means comprise a vertical screw jack 41 driven by a motor 42, a plunger 43 secured to a nut 44 engaged on the screw 41 and prevented from rotating, and a spring 45. The top end of the plunger 43 is designed to come into contact with an abutment of the carriage 8 close to the axis B-B′ for causing the carriage to rock towards the axis A-A′. The spring 45 urges the carriage towards the plunger 43.

The grinder machine 2 also includes a tool-carrier assembly 54, shown in FIG. 2 only, that is secured to the set of grindwheels 12 along the axis A-A′, and pivot means for pivoting the assembly 54 about an axis D perpendicular to the axis A-A′ and intersecting said axis.

The tool-carrier assembly 54 comprises a base 56, a connection arm 58 projecting from the base 56, and a tool-carrier shaft 60 rotatably mounted at the free end of the arm 58 to rotate about an axis substantially orthogonal thereto.

The tool-carrier shaft 60 carries a grooving grindwheel 62, a beveling grindwheel 64, and, at its end, a drill bit 66.

In a first embodiment of the invention, the calibration tool 40 is as shown diagrammatically in FIG. 3.

It comprises a support 68 having mounted thereon a contact detector 70 and a grindwheel-feeler member 72.

The support 68 is generally rectangular or cylindrical in shape, presenting a top face 74, a bottom face 76, and side faces 78 and 80.

The side faces 78 and 80 are provided with recesses 82 and 84 adapted to be engaged on the ends 36 and 38 of the half-shafts of the carriage.

Each side face 78, 80 is extended downwards to form a first support arm 86 and a second support arm 88, respectively. The second support arm 88 is provided at its end with an axial wall 90 extending towards the arm 86.

The contact detector 70 comprises a horizontal piezoelectric plate 92 rigidly secured via one end to the inside face 94 of the first arm 86 and connected by electric wires 96, 98 to an electrical circuit 99 carried by the support 68.

As can be seen in FIG. 4, the piezoelectric plate 92 is constituted by a plurality of superposed layers comprising in succession a protective, first layer 100 made of resin forming an outside face 101 of the piezoelectric element 92, a second layer 102 made of piezoelectric ceramic, a third layer 104 made of titanium, a fourth layer 106 made of piezoelectric ceramic, and finally a last layer 108 made of resin and forming the other outside face 110 of the piezoelectric element.

The electric wires 96, 98 are bonded to respective ones of the ceramic layers 102, 106 so as to transmit to the electrical circuit 99 any current generated by bearing against one of the outside faces 101, 110 so as to impart microdeformation to the piezoelectric plate 92.

The crystals of the ceramic layers 102 and 106 present opposite biases, such that the current flow direction varies as a function of the face on which thrust is applied.

The circuit 99 is suitable for detecting the presence of such a current and for generating a contact detection signal that is transmitted to the grinder machine.

The feeler member 72 is suitable for coming into contact with the surfaces of the grindwheels and for moving so as to transmit pressure to the piezoelectric element 92 in the event of such contact being made. For this purpose, it is fastened on the inside face 112 of the second arm 88 via a horizontal resilient thin plate 114 made for example of spring steel or of cupro-beryllium, . . . .

The feeler member 72 is constituted by a rigid rod 116 having a horizontal and rectilinear fastener portion 118 fastened to the resilient plate 114 and extending it, an angled portion 120, and a rectilinear contact portion 122 that projects relative to the support 68 in a direction perpendicular to the axis B-B′ and that is provided at its end with a feeler tip 124.

Two studs 128 and 130 are formed to project from the contact portion 122 of the rod so as to be positioned on either side of the free end of the piezoelectric plate 92.

Each of the studs 128 and 130 has a respective bearing face 132, 134 facing the piezoelectric plate 92, and each of them is suitable for applying a bearing force on an outside face of the piezoelectric plate 92 during displacement of the feeler member 72.

Two adjustable abutments 136 and 138 serve to limit the displacement stroke of the feeler member 72, being mounted on the support 68 on either side of the contact portion 122 so as to limit its displacement to plus or minus 50 micrometers, so as to avoid the piezoelectric plate 92 being broken under the effect of the force exerted by the studs 128 and 130.

These abutments, e.g. constituted by micrometer screws, are fastened one on the inside face of the wall 90 and the other facing it on the bottom face 76 of the support.

As can be seen in FIG. 5, during lateral contact between the feeler tip 124 and a surface 137A of a grindwheel, the contact force is directed in a direction perpendicular to the axis B-B′, and the feeler member 72 pivots by bending of the resilient plate 114.

During this movement, the bearing face 132 of the stud 128 exerts a force on the top outside face 110 of the piezoelectric plate 92. This force generates a current that is detected by the electrical circuit 99, which transmits a contact detection signal to the grinder machine.

As can be seen in FIG. 6, in the event of the feeler tip 124 of the feeler member coming into contact with the peripheral surface 137B of a grindwheel, then the contact force is directed in a direction perpendicular to the axis B-B′, and the feeler member 72 likewise pivots by bending of the plate 114. During this pivoting, the bearing face 134 of the stud 130 exerts pressure on the bottom face 101 of the piezoelectric plate. This pressure generates a current that is detected by the electrical circuit 99, which in turn produces a contact detection signal.

Thus, regardless of the direction of the contact force between the feeler tip and the surface of a grindwheel, the feeler member 72 is suitable for exerting pressure on the free end of the piezoelectric plate 92, and bending thereof is limited by the abutments 136 and 138.

Similarly, whatever the direction of the contact force, the fastener portion 118 of the feeler member moves in a direction that is substantially perpendicular to the axis B-B′.

The calibration tool 40 serves to discover accurately the diameters of the grindwheels on their level portions and in the bottoms of their chamfers, the drop sides of the grindwheels, the position of the groove in the finishing grindwheel, and the position of the groove in the polishing grindwheel, in order to adjust the precise dimension of the diameter of the lens that is to be ground.

The calibration tool 40 also serves to determine the axial positions of the two sloping faces of the beveling grindwheel, the axial position of the grooving grindwheel, the axial position of the end of the drill bit, and finally the extent to which the tool-carrier shaft is horizontally level, without damaging the tool-carrier assembly.

The calibration tool 40 is suitable for detecting forces of the order of several tenths of a newton and presents accuracy of the order of one-hundredth of a millimeter.

In a variant, the calibration tool is constituted by a support adapted to be mounted on the lens-carrier half-shaft, an encapsulated piezoelectric sensor mounted on the support, and a feeler member fastened to the sensor.

The encapsulated piezoelectric sensor comprises an open cylindrical housing for housing a piezoelectric crystal fastened to the end wall of the housing.

A resilient membrane is mounted on the rim of the housing to form a cap closing the housing. The resilient membrane is positioned facing the piezoelectric crystal at a small distance therefrom.

The feeler member is constituted by a rectilinear rod provided at one end with a feeler tip, and at its other end with a bearing surface fastened on the face of the resilient membrane opposite from its face that faces the piezoelectric element.

On contact being made between the feeler tip and a surface of a grindwheel or a tool of the tool-carrier assembly, the feeler member is displaced relative to the housing by deformation of the resilient membrane. Acting via the membrane, the bearing surface of the feeler member applies pressure against the piezoelectric crystal. This pressure creates microdeformation of the piezoelectric crystal, which in turn generates a current that is detected by the electrical circuit.

In a variant, a plurality of contact detectors may be provided, each comprising a respective feeler member and piezoelectric plate assembly, each detector being active in only one feeling direction.

1-12. (canceled)

13. A calibration tool for a grinder machine for grinding an ophthalmic lens, the machine having two lens-carrier half-shafts carried by a carriage and means for displacing said half-shafts, the calibration tool comprising:
a support adapted to be mounted on the lens-carrier half-shafts;
at least one piezoelectric element fastened to the support; and
at least one feeler member carried by the support, the feeler member having a feeler region and at least one bearing surface suitable, on contact being made between the feeler region and a surface of the grinder machine, for applying a pressure on the piezoelectric element to cause it to generate a detection signal representative of said contact.

14. A calibration tool according to claim 13, wherein the feeler member is mounted to move relative to the support and is suitable for being displaced relative thereto in the event of contact being made between the feeler region and a surface of the grinder machine.

15. A calibration tool according to claim 14, further comprising a resilient element connecting the support to the feeler member, the resilient element being deformed in the event of the feeler member coming into contact with the surface of the grinder machine.

16. A calibration tool according to claim 13, wherein the support includes at least one abutment for limiting the displacement stroke of the feeler region of the feeler member.

17. A calibration tool according to claim 13, wherein the feeler member includes at least two bearing surfaces, each suitable for applying pressure on two respective distinct faces of the piezoelectric element, and wherein the piezoelectric element is suitable for generating two detection signals, each characteristic of the face on which the pressure is applied.

18. A calibration tool according to claim 14, wherein the feeler member includes an angled portion connecting a fastener portion fastened to the resilient element to a contact portion, the fastener portion being suitable for being displaced solely in a direction substantially perpendicular to the axis of the lens-carrier half-shafts during displacement of the contact portion, whether in a direction perpendicular to, or in a direction parallel to, the axis of the lens-carrier half-shafts.

19. A calibration tool according to claim 13, wherein the feeler region of the feeler member is suitable for being displaced solely in a direction substantially perpendicular to the axis of the lens-carrier half-shafts.

20. A calibration tool according to claim 19, including a second piezoelectric element fastened to the support, and a second feeler member suitable for being displaced solely in a direction substantially parallel to said axis of the lens-carrier half-shafts, and suitable for applying pressure against the second piezoelectric element in the event of contact with a second surface of the grinder machine.

21. A calibration tool according to claim 13, wherein the or each piezoelectric element comprises a piezoelectric plate rigidly fastened via one end to the support, and projecting therefrom, said bearing surface of the feeler member being adapted to co-operate with the free end of the piezoelectric plate.

22. A calibration tool according to claim 15, wherein the resilient element comprises a resilient membrane mounted on the support close to the piezoelectric element in such a manner as to present a face facing the piezoelectric element and an opposite face, the bearing surface of the feeler member being fastened on the opposite face of the resilient membrane so that the bearing surface is suitable for applying pressure on the piezoelectric element by deformation of the resilient membrane during displacement of the feeler member.

23. A calibration tool according to claim 15, wherein the resilient element is a thin plate.

24. A grinder machine for grinding an ophthalmic lens and including two lens-carrier half-shafts carried by a carriage and means for displacing said half-shafts, the grinder machine including a calibration tool according to claim 13.
